(19) United States
(12) Patent Application Publication
(10) Pub. No.: US 2026/0267354 A1
(43) Pub. Date: Sep. 10, 2026

(54) METHOD AND APPARATUS FOR CONTROLLING MOVABLE PLATFORM, AND MOVABLE PLATFORM AND STORAGE MEDIUM

(71) Applicant: SZ DJI TECHNOLOGY CO., LTD., Shenzhen (CN)

(72) Inventors: Qifeng WU, Shenzhen (CN); Litian ZHANG, Shenzhen (CN)

(73) Assignee: SZ DJI TECHNOLOGY CO., LTD., Shenzhen (CN)

(21) Appl. No.: 19/661,620

(22) Filed: Apr. 28, 2026

Related U.S. Application Data
(63) Continuation of application No. PCT/CN2023/132251, filed on Nov. 17, 2023.

(51) Int. Cl. G05D 1/686; G05D 3/12; G05D 105/65; G06T 7/20; G06T 7/70; H04N 23/611

(52) U.S. Cl. CPC G05D 1/686; G05D 3/12; G06T 7/20; G06T 7/70; H04N 23/611; G05D 2105/65; G06T 2207/10032; G06T 2207/30196; G06T 2207/30241; G06T 2207/30261

(57) ABSTRACT

A movable platform control method and apparatus, a movable platform, and a storage medium are provided. The method includes: obtaining a current first motion progress of a followed target on a preset target trajectory; and controlling a second motion progress of a movable platform on a preset following trajectory based on the first motion progress. The second motion progress is related to the first motion progress. In this way, a user does not need to manually control the movable platform, making an entire following process intelligent and more convenient.

### RELATED APPLICATIONS

This application is a continuation application of PCT application No. PCT/CN2023/132251, filed on Nov. 17, 2023, and the content of which is incorporated herein by reference in entirety.

### TECHNICAL FIELD

Embodiments of the present disclosure relate to the technical field of intelligent control, and specifically, to a method and apparatus for controlling a movable platform, a movable platform, and a storage medium.

### BACKGROUND

In many scenarios, a target needs to be followed by a movable platform. In a following process, the movable platform and the followed target usually need to closely cooperate to ensure that they may move based on their respective predetermined trajectories, thereby achieving an expected following effect. At present, in most of such following scenarios, a user manually controls the movable platform to follow the followed target, which is difficult to control and cumbersome to operate.

For example, in a film and television shooting scenario, when some long shots are captured, both a photographed subject and a photographing apparatus usually need to move based on their respective predetermined trajectories, and closely cooperate to capture images with an expected effect. Currently, in such shooting scenarios, the photographing apparatus is usually mounted on a movable platform, and a user manually controls the movable platform to move to follow the photographed subject and complete shooting. This method is difficult to control and not convenient enough. Therefore, it is necessary to provide a more intelligent following solution.

### SUMMARY

In view of this, the present disclosure provides a movable platform control method and apparatus, a movable platform, and a storage medium.

According to a first aspect of the present disclosure, a movable platform control method is provided. The method includes: obtaining a current first motion progress of a followed target on a preset target trajectory; and controlling a second motion progress of a movable platform on a preset following trajectory based on the first motion progress, where the second motion progress is related to the first motion progress.

According to a second aspect of the present disclosure, a movable platform control apparatus is provided, including: at least one storage medium storing at least one set of instructions; and at least one processor in communication with the at least one storage medium, where during operation, the at least one processor executes the at least one set of instructions to cause the control apparatus to at least perform: obtaining a current first motion progress of a followed target on a preset target trajectory, and controlling a second motion progress of a movable platform on a preset following trajectory based on the first motion progress, where the second motion progress is related to the first motion progress.

According to a third aspect of the present disclosure, a computer-readable storage medium is provided, the computer-readable storage medium stores a computer program, and the computer program, when executed, implements a method including the following steps: obtaining a current first motion progress of a followed target on a preset target trajectory; and controlling a second motion progress of a movable platform on a preset following trajectory based on the first motion progress, where the second motion progress is related to the first motion progress.

Through the solutions provided in the present disclosure, in a following scenario where a followed target and a movable platform each need to move based on a preset trajectory, their motion trajectories may be recorded. When the movable platform follows the followed target, a first characteristic value of a motion characteristic of the followed target on a target trajectory may be obtained. Then, a second characteristic value of the motion characteristic of the movable platform on a following trajectory may be controlled based on the first characteristic value such that both characteristic values of the motion characteristic meet a preset condition. In this way, a user does not need to manually control the movable platform, making an entire following process intelligent and more convenient.

It should be understood that the foregoing general description and the following detailed description are merely exemplary and explanatory, and should not be construed as a limitation to the present disclosure.

### BRIEF DESCRIPTION OF THE DRAWINGS

To describe the technical solutions in the embodiments of the present disclosure more clearly, the accompanying drawings required to describe the embodiments are briefly described below. Apparently, the accompanying drawings described below show merely some exemplary embodiments of the present disclosure. Those of ordinary skill in the art may further obtain other accompanying drawings based on these accompanying drawings without creative efforts.

FIG. 1 is a schematic diagram of an application scenario according to some exemplary embodiments of the present disclosure;

FIG. 2 is a schematic diagram of an application scenario according to some exemplary embodiments of the present disclosure;

FIG. 3 is a flowchart of a movable platform control method according to some exemplary embodiments of the present disclosure;

FIG. 4 is a schematic diagram of an application scenario according to still some exemplary embodiments of the present disclosure;

FIG. 5 is a schematic diagram of a first motion progress represented by a travel ratio according to some exemplary embodiments of the present disclosure;

FIG. 6 is a schematic diagram of a first motion progress represented by a time ratio according to some exemplary embodiments of the present disclosure;

FIG. 7 is a schematic diagram of projecting a target position point at which a followed target is currently located onto a target trajectory according to some exemplary embodiments of the present disclosure;

FIG. 8 is a schematic diagram of an interaction interface according to some exemplary embodiments of the present disclosure; and

FIG. 9 is a schematic diagram of a logical structure of a control apparatus according to some exemplary embodiments of the present disclosure.

### DETAILED DESCRIPTION

The technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

In many scenarios, a followed target needs to be followed through a movable platform. In a following process, a position relationship between the movable platform and the followed target usually needs to meet a specific condition to achieve an expected following effect. In the following process, a motion status of the followed target changes in real time, and close cooperation between the movable platform and the followed target needs to be ensured. If a user manually controls the movable platform to follow the followed target, it is often difficult to control and cumbersome to operate.

At present, in some following scenarios, it is possible to achieve completely automatic following by the movable platform without manual control by the user, such as intelligent following and parallel following scenarios. In such scenarios, it is usually only necessary to ensure that a relative position relationship between the movable platform and the followed target meets the specific condition in the following process, such as maintaining a distance of 2 m between them. In such following scenarios, there is usually no need to preset a motion trajectory of the movable platform. In other words, there is no requirement for the motion trajectory of the movable platform. The movable platform can automatically adjust its own motion trajectory based on a motion trajectory of the followed target to achieve automatic following.

However, in some scenarios, both the movable platform and the followed target may need to move based on their respective predetermined trajectories. In other words, there are requirements for both motion trajectories. For example, in a film and television shooting scenario, when some long shots are captured, motion trajectories of a photographed subject and a photographing apparatus are usually designed in advance, and both need to move based on their respective predetermined trajectories to closely cooperate, thereby capture images with an expected effect.

At present, in most of following scenarios where the movable platform and the followed target each need to move based on a predetermined trajectory, the user manually controls the movable platform to follow the followed target, which is difficult to control and cumbersome to operate.

Certainly, to reduce control difficulty, in some solutions, a following trajectory of the movable platform may be pre-stored. During motion of the followed target, the movable platform may be controlled to move based on the stored following trajectory. In such scenarios, because a motion trajectory has been set, the user only needs to adjust a motion speed of the movable platform based on an observed motion status of the followed target. Control is slightly simpler, but it still needs to rely on the user's manual operation, which is cumbersome and not intelligent enough.

In view of this, the embodiments of the present disclosure provide a movable platform control method. In a following scenario where a followed target and a movable platform each need to move based on a preset trajectory, their motion trajectories may be recorded (for ease of differentiation, a preset motion trajectory of the followed target is referred to as a target trajectory and a preset motion trajectory of the movable platform is referred to as a following trajectory below). When the movable platform follows the followed target, a first characteristic value of a motion characteristic of the followed target on the target trajectory may be obtained. Then, a second characteristic value of the motion characteristic of the movable platform on the following trajectory may be controlled based on the first characteristic value such that both characteristic values of the motion characteristic meet a preset condition. In this way, a user does not need to manually control the movable platform, making an entire following process intelligent and more convenient.

The motion characteristic may be a motion progress (or movement progress), motion step, motion speed, or the like of the followed target on the target trajectory (or the movable platform on the following trajectory). The following uses an example in which the motion characteristic is the motion progress for description.

The movable platform in the embodiments of the present disclosure may be various devices that can move autonomously, for example, an aerial vehicle such as an unmanned aerial vehicle (UAV), a vehicle such as an unmanned vehicle, or a shipping and transportation device such as an unmanned ship.

The followed target in the embodiments of the present disclosure may be a single target object or a cluster composed of a plurality of target objects. The followed target may be a person (for example, a performer), a device or a device cluster (for example, a vehicle, or a UAV cluster configured to perform in the air), a changing pattern, or the like. This is not limited in the embodiments of the present disclosure.

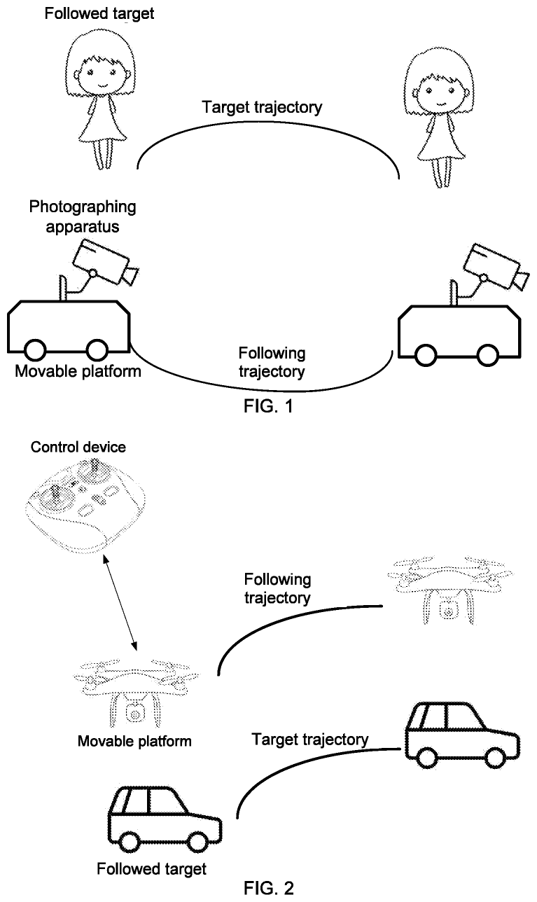

In some exemplary embodiments, the control method in the embodiments of the present disclosure may be performed by the movable platform. For example, FIG. 1 is a schematic diagram of an application scenario according to the present disclosure. For example, a photographed subject may be an actor, and the movable platform may be an unmanned vehicle on which a photographing apparatus is mounted. The unmanned vehicle may obtain a first motion progress of the actor and control its own second motion progress on the following trajectory to follow and photograph the actor.

In some exemplary embodiments, the control method in the embodiments of the present disclosure may be performed by a control device communicatively connected to the movable platform. The control device may be a remote control, a mobile phone, an intelligent wearable device such as smart glasses, a cloud server, or the like configured to control the movable platform. The remote control may be a remote control carried by a user of the movable platform, or a remote control carried by a target that the movable platform needs to follow. For example, FIG. 2 is a schematic diagram of an application scenario according to the present disclosure. For example, a photographed subject may be a moving vehicle, the movable platform may be a UAV on which a photographing apparatus is mounted, and the control device may be a remote control configured to control the UAV. The remote control may obtain a first motion progress of the vehicle, and then control a second motion progress of the UAV on the following trajectory based on the first motion progress.

It should be noted that an execution entity of each step of the control method in the embodiments of the present disclosure may be flexibly set based on an actual requirement. This is not limited in the embodiments of the present disclosure.

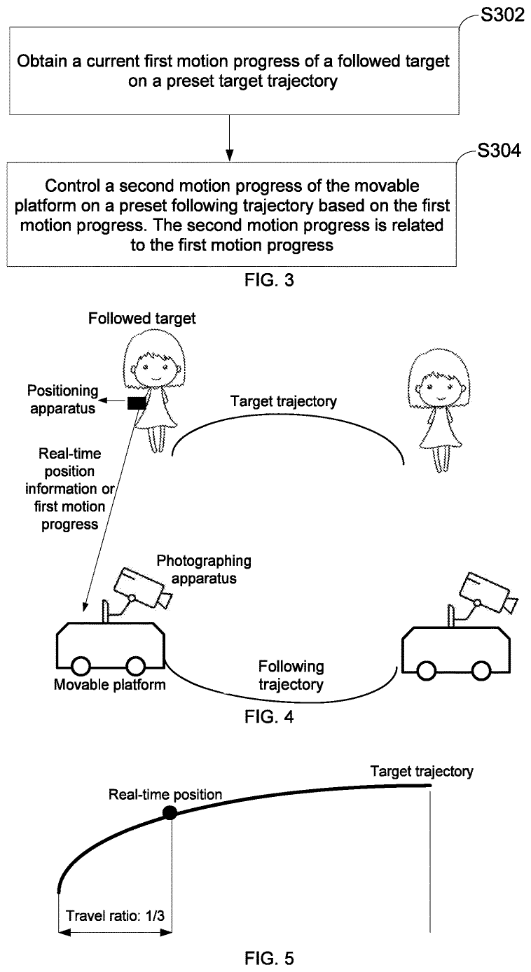

FIG. 3 is a flowchart of a control method according to some exemplary embodiments of the present disclosure. The method may specifically include the following steps.

S302: Obtain a current first motion progress of a followed target on a preset target trajectory.

In step S302, the current first motion progress of the followed target on the preset target trajectory may be obtained. The target trajectory may be an expected motion trajectory of the followed target. The target trajectory may be generated and stored in advance, or may be temporarily generated in a following process. For example, the target trajectory of the followed target may be stored in a movable platform, a control device of the movable platform, or a third-party device (for example, a cloud server), or may be stored in a positioning apparatus carried by the followed target. This may be flexibly set based on an actual requirement. When the first motion progress is determined based on the target trajectory, the target trajectory may be obtained from the foregoing device based on an actual storage location.

The first motion progress may be various pieces of information that reflects a motion progress of the followed target on the target trajectory, for example, may be a travel progress of the followed target during motion on the target trajectory, or a time progress of the followed target during motion on the target trajectory.

In some exemplary embodiments, as shown in FIG. 4, the followed target may carry a positioning apparatus. The first motion progress may be determined by the positioning apparatus based on real-time position information of the followed target obtained by the positioning apparatus and the target trajectory. The movable platform or a control device performing the control method may obtain the first motion progress from the positioning apparatus, and then control the movable platform based on the first motion progress.

In some exemplary embodiments, as shown in FIG. 4, alternatively, the movable platform or the control device may obtain the real-time position information of the followed target obtained by the positioning apparatus, and then determine the first motion progress based on the obtained real-time position information and the target trajectory.

S304: Control a second motion progress of the movable platform on a preset following trajectory based on the first motion progress. The second motion progress is related to the first motion progress.

In step S304, it is considered that the motion progresses of the movable platform and the followed target usually need to meet a specific condition to achieve an expected following effect. For example, for film and television shooting, both progresses need to be consistent or cannot differ too much, to ensure that a captured image meets expectations. Therefore, after the first motion progress of the followed target on the preset target trajectory is obtained, the second motion progress of the movable platform on the preset following trajectory may be controlled based on the first motion progress. The second motion progress is related to the first motion progress.

Similarly, the following trajectory of the movable platform may be generated and stored in advance, or may be temporarily generated in the following process. For example, the following trajectory may be stored in the movable platform, the control device of the movable platform, or a third-party device (for example, a cloud server). When the second motion progress is determined based on the following trajectory, the following trajectory may be obtained from the foregoing device based on an actual storage location.

A device (for example, the movable platform or the control device) performing the control method may perform the control method at regular intervals to ensure that both motion progresses can meet a requirement in the following process.

In some exemplary embodiments, during motion, the followed target may keep its attitude unchanged and change only its position, keep its position unchanged and change only its attitude, or change both its position and attitude. Therefore, the target trajectory may be a position change trajectory and/or an attitude change trajectory of the followed target.

Similarly, in some exemplary embodiments, in a process of following the followed target, the movable platform may also keep its attitude unchanged and change only its position, keep its position unchanged and change only its attitude, or change both its position and attitude. Therefore, the following trajectory may be a position change trajectory and/or an attitude change trajectory of the movable platform.

In some exemplary embodiments, a load, such as a gimbal, may be further disposed on the movable platform. When the followed target is followed, a position and/or an attitude of the load mounted on the movable platform may alternatively be controlled to change. Therefore, the following trajectory may alternatively be a position change trajectory and/or an attitude change trajectory of the load.

For example, in a scenario where the followed target is followed and photographed, a photographing apparatus may be mounted on the gimbal of the movable platform. The gimbal moves to drive the photographing apparatus to move, to photograph the followed target. Therefore, the following trajectory may be a position change trajectory and/or an attitude change trajectory of the gimbal in a following and photographing process.

In some exemplary embodiments, the followed target may be a single target object. Therefore, the target trajectory may be a motion trajectory of the single target object. In some exemplary embodiments, the followed target may be a cluster composed of a plurality of target objects. In this case, the plurality of target objects may be abstracted into a target point. For example, the target point (such as a center point of the cluster) may be determined based on the cluster. The target trajectory may be a motion trajectory of the target point.

In some exemplary embodiments, the followed target is a cluster composed of a plurality of target objects. The target trajectory may alternatively be a motion trajectory of a performance pattern formed by the plurality of target objects during motion. For example, for a UAV formation performing a light show in the air, a performance pattern formed during the show usually changes in a specific manner. Therefore, the target trajectory may alternatively be a motion trajectory of the performance pattern. For example, a motion trajectory of a target point (such as a center of the performance pattern) in the performance pattern may be recorded as the target trajectory.

In some exemplary embodiments, the followed target may be an aerial vehicle cluster performing in the air.

In some exemplary embodiments, as shown in FIG. 5, the first motion progress may be the travel progress of the followed target on the target trajectory, for example, may be a proportion of a covered travel of the followed target on the target trajectory in a total travel corresponding to the target trajectory.

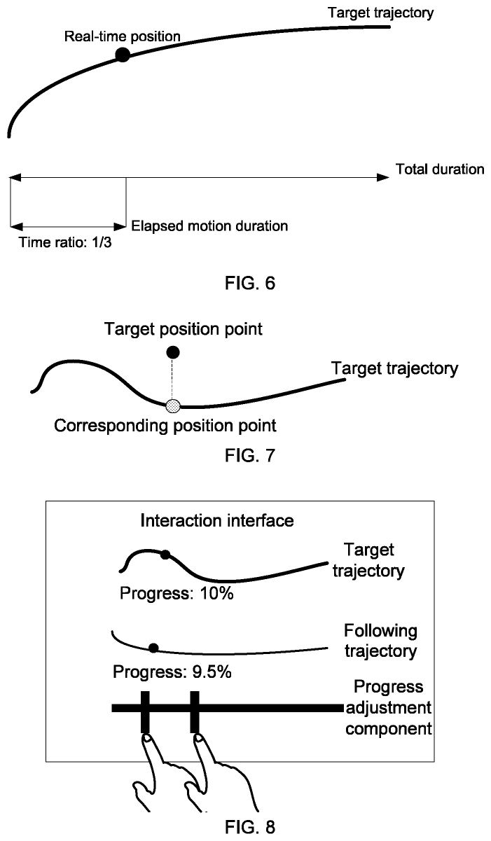

In some exemplary embodiments, as shown in FIG. 6, the first motion progress may be the time progress of the followed target on the target trajectory, for example, may be a proportion of elapsed motion duration of the followed target on the target trajectory in total motion duration corresponding to the target trajectory.

In some exemplary embodiments, if the first motion progress is the travel progress of the followed target on the target trajectory, the first motion progress may be determined based on real-time position information of the followed target. For example, a current position of the followed target on the target trajectory may be determined based on the real-time position information of the followed target and the target trajectory. Then, the covered travel of the followed target may be determined. In combination with the total travel corresponding to the target trajectory, the travel progress can be obtained.

In some exemplary embodiments, if the first motion progress is the time progress of the followed target on the target trajectory, because the total motion duration of the followed target on the target trajectory is usually known in advance and may be recorded, the first motion progress can be determined by determining only the current elapsed motion duration of the followed target on the target trajectory.

In some scenarios, the elapsed motion duration of the followed target on the target trajectory may be determined based on the real-time position information of the followed target. For example, it may be determined based on the real-time position information of the followed target whether the followed target has moved on the target trajectory. After it is determined that the followed target has moved on the target trajectory, timing is started and the current elapsed motion duration of the followed target is counted.

In some scenarios, the elapsed motion duration may alternatively be determined without using the real-time position information of the followed target. For example, in a scenario where the followed target can communicate with the movable platform, such as when the followed target is a vehicle, a UAV, or the like, when starting to move based on the target trajectory, the followed target may send a signal to the movable platform. After receiving the signal, the movable platform starts timing such that the current elapsed motion duration of the followed target can be counted. Alternatively, in a scenario where the followed target is an actor or the like and cannot communicate with the movable platform, the movable platform may obtain a video of the followed target and analyze the video to determine whether the followed target starts to move on the target trajectory, and after determining that it starts to move on the target trajectory, starts timing and counts the current elapsed motion duration.

In such scenarios, because the first motion progress can be determined without using the real-time position information of the followed target, the followed target is not required to carry a positioning apparatus, which is more convenient.

In some exemplary embodiments, the followed target carries a positioning apparatus or another terminal device (for example, a wearable device) with a positioning apparatus mounted. The real-time position information may be obtained by the positioning apparatus. For example, the positioning apparatus may be a global positioning system (GPS) apparatus or another apparatus that can obtain the real-time position information.

In some exemplary embodiments, a perception sensor is disposed on the movable platform. The real-time position information may alternatively be determined based on data obtained by the perception sensor. For example, the perception sensor may be one or more of a vision sensor, a radar, or an ultra-wideband (UWB) positioning system. After acquiring sensing data of the followed target through the perception sensor, the movable platform may determine the real-time position information of the followed target based on the sensing data.

In some exemplary embodiments, the real-time position information of the followed target may alternatively be determined by combining the foregoing two manners, to obtain more accurate real-time position information.

In some exemplary embodiments, during motion of the followed target, it is difficult to completely follow the preset target trajectory, but there may be some deviations from the target trajectory. For example, as shown in FIG. 7, a target position point at which the followed target is currently located may not be on the target trajectory. Therefore, when the first motion progress is determined based on the real-time position information of the followed target, the target position point at which the followed target is currently located may be first projected onto the target trajectory to determine a corresponding position point of the target position point on the target trajectory, and then the first motion progress is determined based on the corresponding position point. For example, to determine the covered travel of the followed target on the target trajectory, if it is determined based on the real-time position information of the followed target that the target position point at which the followed target is currently located is not on the target trajectory, the corresponding position point of the target position point is determined on the target trajectory, and the covered travel of the followed target is determined based on the corresponding position point and the target trajectory. A distance between the corresponding position point and the target position point may meet a specific condition.

For example, in some exemplary embodiments, to more accurately determine the first motion progress of the followed target on the target trajectory, a position point on the target trajectory closest to the target position point at which the followed target is currently located may be selected as the corresponding position point.

In some exemplary embodiments, if the target trajectory is a position change trajectory of the followed target, the covered travel is a covered distance of the followed target, and the total travel is a total distance corresponding to the target trajectory. For example, assuming that the target trajectory is a motion trajectory of the followed target moving from a point A to a point B, the total travel is a total distance corresponding to the motion trajectory, and the covered travel is a distance that the photographed target has covered on the motion trajectory.

In some exemplary embodiments, if the target trajectory is an attitude change trajectory of the followed target, the covered travel is an attitude change that the followed target has undergone, and the total travel is a total attitude change corresponding to the target trajectory. For example, assuming that the target trajectory is a motion trajectory of the followed target rotating from an angle X to an angle Y, the total travel is a total angle change (for example, Y-X) corresponding to the motion trajectory, and the covered travel is an angle by which the photographed target has rotated.

In some exemplary embodiments, if the followed target is an aerial vehicle cluster performing in the air, the elapsed motion duration is elapsed performance duration of the followed target, and the total duration is total performance duration of the followed target.

In some exemplary embodiments, the followed target is an aerial vehicle cluster performing in the air. The target trajectory may be a performance pattern change trajectory of a plurality of aerial vehicles in the aerial vehicle cluster. The covered travel is a change trajectory of an executed performance pattern of the plurality of aerial vehicles. The total travel is a change trajectory of a total performance pattern of the plurality of aerial vehicles. In this implementation, a plurality of UAVs in a UAV cluster are configured to perform a UAV show in the air (each UAV is provided with a light, and positions and light colors of different UAVs are controlled to implement the show). In addition, there is a UAV configured to shoot a performance process of the performing UAV cluster, to generate a performance video. In this scenario, the shooting UAV may plan the following trajectory in advance based on an optimal shooting position, and the performing UAV cluster may plan the target trajectory in advance based on a pattern to be performed. In an actual shooting process, the shooting UAV controls its own motion progress on the following trajectory based on a performance progress of the performing UAVs, to shoot the performance video from an optimal perspective.

In some exemplary embodiments, that the second motion progress is related to the first motion progress may include any one of the following cases:
(1) The second motion progress is consistent with the first motion progress. For example, the motion progress is represented by a travel percentage. If the covered travel of the photographed target on the target trajectory accounts for 10% of the total travel, a covered travel of the movable platform on the following trajectory may be controlled to account for 10% of a total travel.
(2) A ratio of the second motion progress to the first motion progress is a target ratio. For example, the ratio of the second motion progress to the first motion progress may be maintained at the target ratio, such as 1:1.1. If the covered travel of the followed target on the target trajectory accounts for 10% of the total travel, a covered travel of the movable platform on the following trajectory may be controlled to account for 11% of a total travel.

In some exemplary embodiments, the target ratio may be preset and stored by a user. In the following process, the pre-stored ratio may be obtained as the target ratio.

In some exemplary embodiments, after the user sets the ratio, the user may further adjust the ratio in real time in the following process. For example, the device performing the control method may receive a ratio adjustment instruction of the user and adjust the pre-stored ratio based on the ratio adjustment instruction to obtain the target ratio.

In some exemplary embodiments, in a scenario where the movable platform follows and photographs the followed target, to capture an optimal image in the entire following process, the target ratio may alternatively be automatically adjusted dynamically. For example, the target ratio may be determined based on a composition of the followed target in an image obtained by a photographing apparatus mounted on the movable platform, to ensure that the followed target remains as close to a central position of the image as possible.

(3) A difference between the second motion progress and the first motion progress is less than a preset difference threshold. For example, because it is difficult to control both motion progresses to be completely consistent, both motion progresses do not need to be kept completely consistent, provided that the difference between them is less than the preset difference threshold and within a specific difference range.

Lengths, change trends, or the like of the target trajectory and the following trajectory may be consistent or inconsistent. For example, in some exemplary embodiments, the lengths of the target trajectory and the following trajectory may be inconsistent. In some exemplary embodiments, the change trends of the target trajectory and the following trajectory are at least partially inconsistent.

In some exemplary embodiments, after the second motion progress of the movable platform on the following trajectory is automatically determined based on the first motion progress, the user may further manually fine-tune the second motion progress. For example, a motion progress adjustment instruction input by the user may be obtained, and the movable platform may be controlled based on the motion progress adjustment instruction to move to adjust the second motion progress. For example, as shown in FIG. 8, the target trajectory of the followed target, the current first motion progress of the followed target, the following trajectory of the movable platform, and the current second motion progress of the movable platform may be displayed on an interaction interface of the control device of the movable platform. Then, a progress adjustment component for manually adjusting the second motion progress may be set on the interaction interface. The user may adjust the second motion progress through the progress adjustment component based on observed current real-time motion conditions of the followed target and the movable platform.

In some exemplary embodiments, when the second motion progress of the movable platform on the following trajectory is controlled based on the first motion progress, a position movement speed and/or an attitude change speed of the movable platform may be adjusted based on the first motion progress to adjust the second motion progress of the movable platform on the following trajectory.

In some exemplary embodiments, when the position movement speed and/or the attitude change speed of the movable platform are adjusted based on the first motion progress such that both motion progresses meet a preset requirement, the position movement speed and/or the attitude change speed are positively correlated with a target difference. The target difference is a difference between a current motion progress and an expected motion progress of the movable platform. The expected motion progress is a motion progress meeting the preset requirement with the first motion progress. For example, if both motion progresses need to be kept consistent, assuming that the currently obtained first motion progress of the followed target on the target trajectory is 10% and the second motion progress of the movable platform on the following trajectory is 8%, the position change speed and/or the attitude change speed of the movable platform may be adjusted based on the difference between them. The greater the difference, the greater the position change speed and/or the attitude change speed of the movable platform, to ensure that both progresses can be consistent as soon as possible.

When the movable platform is controlled to ensure that the motion progresses of the movable platform and the followed target meet the preset requirement, a position, an attitude, a speed, or the like of the movable platform may be controlled through a proportional integral derivative (PID) control algorithm or an optimal control algorithm.

In some exemplary embodiments, the target trajectory of the followed target may be generated and stored in advance. For example, when the followed target moves based on a preplanned motion trajectory, position and/or attitude information of the followed target may be sampled at intervals to obtain a plurality of sampling points, and then the target trajectory may be generated based on the plurality of sampling points. When the target trajectory is generated based on the plurality of sampling points, a Bézier curve or a polynomial curve may be generated to simulate the target trajectory. The target trajectory may alternatively be preset on a trajectory editing page (for example, the trajectory may be planned by marking points on a map or an image captured in real time) of a control apparatus (such as a remote control of the movable platform or a controller carried by the followed target) or on a page of another terminal device. The preset target trajectory is imported into the movable platform or a control apparatus of the movable platform in a wired or wireless manner.

Certainly, in some exemplary embodiments, alternatively, the target trajectory does not need to be directly stored, and the target trajectory may be temporarily generated in the following process. For example, an initial position and/or an initial attitude of the followed target, and a position change trend and/or an attitude change trend of the followed target may be stored. Then, the target trajectory may be generated based on the initial position and/or the initial attitude, and the position change trend and/or the attitude change trend.

Similarly, the following trajectory of the movable platform may also be generated in the foregoing two manners. Details are not described herein again.

In some exemplary embodiments, the target trajectory and/or the following trajectory may be generated before the movable platform follows the followed target. For example, before the followed target is followed, the target trajectory may be generated and stored in advance. When the followed target is followed subsequently, the stored target trajectory may be directly called.

In some exemplary embodiments, the target trajectory and/or the following trajectory may be generated after the movable platform follows the followed target. For example, after the movable platform follows the followed target, the target trajectory may be predicted based on the change trend of the target trajectory and/or the following trajectory, and then the target trajectory may be generated.

In some exemplary embodiments, the movable platform may be a UAV. That the target trajectory and/or the following trajectory are generated before the movable platform follows the followed target may be that the target trajectory and/or the following trajectory are generated before the movable platform takes off, or the target trajectory and/or the following trajectory are generated after the movable platform takes off.

In some exemplary embodiments, a photographing apparatus is mounted on the movable platform. When the movable platform follows the followed target, the photographing apparatus may be controlled to obtain an image of the followed target.

In some exemplary embodiments, to ensure that an image with a good effect is obtained, when the movable platform follows the followed target and obtains the image of the followed target, it may be ensured that the followed target is located at a central position of at least one image obtained by the photographing apparatus. For example, when the movable platform follows the followed target, it should be ensured that the followed target is located at a center of the image obtained by the photographing apparatus for at least part of a time period to ensure a photographing effect.

In some exemplary embodiments, the method may be used in a film and television shooting scenario. In addition to controlling the movable platform based on the first motion progress of the followed target on the target trajectory, a target prop may be further controlled based on the first motion progress to perform a preset action. For example, in some scenarios where an explosive phenomenon needs to be captured, an actor usually needs to walk to a fixed position and ignite an explosive apparatus such that a video including the explosive phenomenon can be captured. Therefore, the explosive apparatus may also be automatically controlled based on the first motion progress of the followed target to detonate.

In some exemplary embodiments, the control method may be performed by the movable platform. The target trajectory of the followed target may be stored in the control device of the movable platform. The movable platform may obtain the target trajectory from the control device, obtain real-time position information of the followed target from a positioning apparatus carried by the followed target, and determine the first motion progress based on the real-time position information and the target trajectory. Then, the movable platform may adjust its own motion speed on the preset following trajectory based on the first motion progress such that the second motion progress of the movable platform on the following trajectory is consistent with the first motion progress.

In addition, the embodiments of the present disclosure further provide a movable platform control method, including:
obtaining a current first characteristic value of a motion characteristic of a followed target on a preset target trajectory; and
controlling a second characteristic value of the motion characteristic of a movable platform on a preset following trajectory based on the first characteristic value, where the second characteristic value is related to the first characteristic value.

In some exemplary embodiments, the motion characteristic includes one or more of the following:
a motion progress, a motion speed, or a motion step.

In some exemplary embodiments, the first characteristic value is determined based on real-time position information of the followed target.

In some exemplary embodiments, the motion characteristic is a motion progress. The first characteristic value is a proportion of a covered travel of the followed target on the target trajectory in a total travel corresponding to the target trajectory.

Alternatively, the first characteristic value is a proportion of elapsed motion duration of the followed target on the target trajectory in total motion duration corresponding to the target trajectory.

In some exemplary embodiments, the covered travel is determined based on the real-time position information of the followed target and the target trajectory.

In some exemplary embodiments, the followed target carries a positioning apparatus, and the real-time position information is obtained by the positioning apparatus; and/or
a perception sensor is disposed on the movable platform, and the real-time position information is determined based on data obtained by the perception sensor.

In some exemplary embodiments, the perception sensor includes one or more of a vision sensor, a radar, or a UWB positioning system.

In some exemplary embodiments, that the covered travel is determined based on the real-time position information of the followed target and the target trajectory includes:

If it is determined based on the real-time position information of the followed target that a target position point at which the followed target is currently located is not on the target trajectory, a corresponding position point of the target position point is determined on the target trajectory, and the covered travel is determined based on the corresponding position point and the target trajectory.

In some exemplary embodiments, the corresponding position point is a position point closest to the target position point on the target trajectory.

In some exemplary embodiments, that the second characteristic value is related to the first characteristic value includes:
the second characteristic value is consistent with the first characteristic value;
a ratio of the second characteristic value to the first characteristic value is a target ratio; or
a difference between the second characteristic value and the first characteristic value is less than a preset difference threshold.

In some exemplary embodiments, the target ratio is obtained based on any one of the following manners:
obtaining a pre-stored ratio as the target ratio;
receiving a ratio adjustment instruction from a user, and adjusting the pre-stored ratio based on the ratio adjustment instruction to obtain the target ratio; or
with a photographing apparatus mounted on the movable platform, determining the target ratio based on a composition of the followed target in an image obtained by the photographing apparatus.

In some exemplary embodiments, after controlling the second characteristic value of the motion characteristic of the movable platform on the following trajectory based on the first characteristic value, the method further includes:
obtaining a motion progress adjustment instruction from a user, and controlling, based on the motion progress adjustment instruction, the movable platform to move to adjust the second characteristic value.

In some exemplary embodiments, controlling the second characteristic value of the motion characteristic of the movable platform on the following trajectory based on the first characteristic value includes:
adjusting a position movement speed and/or an attitude change speed of the movable platform based on the first characteristic value to adjust the second characteristic value of the movable platform on the following trajectory.

In some exemplary embodiments, the position movement speed and/or the attitude change speed are positively correlated with a target difference. The target difference is a difference between a current characteristic value and an expected characteristic value of the motion characteristic of the movable platform. The expected characteristic value is related to the first characteristic value.

In some exemplary embodiments, the method is used in a film and television shooting scenario. The method further includes:
controlling, based on the first characteristic value, a target prop to perform a preset action.

In some exemplary embodiments, the method is performed by the movable platform, or the method is performed by a control device communicatively connected to the movable platform.

In some exemplary embodiments, the followed target carries a positioning apparatus. The first characteristic value is determined by the positioning apparatus based on real-time position information of the followed target obtained by the positioning apparatus and the target trajectory. The movable platform or the control device obtains the first characteristic value from the positioning apparatus.

In some exemplary embodiments, the followed target carries a positioning apparatus. The movable platform or the control device is configured to obtain real-time position information of the followed target obtained by the positioning apparatus, and determine the first characteristic value based on the real-time position information and the target trajectory.

In some exemplary embodiments, the target trajectory is obtained from the control device of the movable platform or from a third-party device.

In some exemplary embodiments, the obtaining a current first characteristic value of a motion characteristic of a followed target on a preset target trajectory includes:
obtaining, by the movable platform, the target trajectory of the followed target from a control device, obtaining real-time position information of the followed target from a positioning apparatus carried by the followed target, and determining the first characteristic value based on the real-time position information and the target trajectory.

The controlling a second characteristic value of the motion characteristic of a movable platform on a preset following trajectory based on the first characteristic value includes:
adjusting, by the movable platform, a motion speed of the movable platform on the preset following trajectory based on the first characteristic value such that the second characteristic value of the motion characteristic of the movable platform on the following trajectory is consistent with the first characteristic value.

It is not difficult to understand that the solutions described in the foregoing embodiments may be freely combined into new solutions in the absence of conflicts. Due to space limitations, they are not enumerated in the embodiments of the present disclosure.

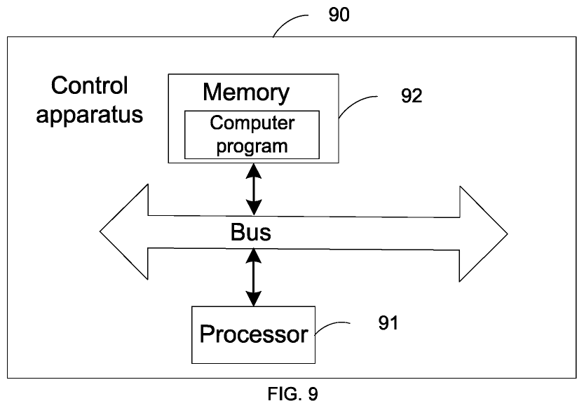

Corresponding to the foregoing method, the embodiments of the present disclosure further provide a movable platform control apparatus. As shown in FIG. 9, the control apparatus includes a processor 91, a memory 92, and a computer program stored in the memory 92 and executable by the processor 91. When executing the computer program, the processor 91 may implement the following steps:
obtaining a current first motion progress of a followed target on a preset target trajectory; and
controlling a second motion progress of a movable platform on a preset following trajectory based on the first motion progress, where the second motion progress is related to the first motion progress.

In some exemplary embodiments, the target trajectory is a position change trajectory and/or an attitude change trajectory of the followed target.

In some exemplary embodiments, the following trajectory is a position change trajectory and/or an attitude change trajectory of the movable platform.

Alternatively, a load is disposed on the movable platform, and the following trajectory is a position change trajectory and/or an attitude change trajectory of the load.

In some exemplary embodiments, the followed target is a cluster composed of a plurality of target objects. The target trajectory is a motion trajectory of a target point determined based on the cluster.

In some exemplary embodiments, the followed target is a cluster composed of a plurality of target objects. The target trajectory is a motion trajectory of a performance pattern formed by the plurality of target objects during motion.

In some exemplary embodiments, the followed target is an aerial vehicle cluster performing in the air.

In some exemplary embodiments, the first motion progress is determined based on real-time position information of the followed target.

In some exemplary embodiments, the first motion progress is a proportion of a covered travel of the followed target on the target trajectory in a total travel corresponding to the target trajectory.

Alternatively, the first motion progress is a proportion of elapsed motion duration of the followed target on the target trajectory in total motion duration corresponding to the target trajectory.

In some exemplary embodiments, the covered travel is determined based on the real-time position information of the followed target and the target trajectory.

In some exemplary embodiments, the followed target carries a positioning apparatus, and the real-time position information is obtained by the positioning apparatus; and/or
a perception sensor is disposed on the movable platform, and the real-time position information is determined based on data obtained by the perception sensor.

In some exemplary embodiments, the perception sensor includes one or more of a vision sensor, a radar, or a UWB positioning system.

In some exemplary embodiments, that the covered travel is determined based on the real-time position information of the followed target and the target trajectory includes:

If it is determined based on the real-time position information of the followed target that a target position point at which the followed target is currently located is not on the target trajectory, a corresponding position point of the target position point is determined on the target trajectory, and the covered travel is determined based on the corresponding position point and the target trajectory.

In some exemplary embodiments, the corresponding position point is a position point closest to the target position point on the target trajectory.

In some exemplary embodiments, the target trajectory is a position change trajectory of the followed target, the covered travel is a covered distance of the followed target, and the total travel is a total distance corresponding to the target trajectory; and/or
the target trajectory is an attitude change trajectory of the followed target, the covered travel is an attitude change that the followed target has undergone, and the total travel is a total attitude change corresponding to the target trajectory.

In some exemplary embodiments, the followed target is an aerial vehicle cluster performing in the air. The elapsed motion duration is elapsed performance duration of the followed target. The total duration is total performance duration of the followed target.

In some exemplary embodiments, the followed target is an aerial vehicle cluster performing in the air. The target trajectory is a performance pattern change trajectory of a plurality of aerial vehicles in the aerial vehicle cluster. The covered travel is a change trajectory of an executed performance pattern of the plurality of aerial vehicles. The total travel is a change trajectory of a total performance pattern of the plurality of aerial vehicles.

In some exemplary embodiments, that the second motion progress is related to the first motion progress includes:
the second motion progress is consistent with the first motion progress;
a ratio of the second motion progress to the first motion progress is a target ratio; or
a difference between the second motion progress and the first motion progress is less than a preset difference threshold.

In some exemplary embodiments, the target ratio is obtained based on any one of the following manners:
obtaining a pre-stored ratio as the target ratio;
receiving a ratio adjustment instruction from a user, and adjusting the pre-stored ratio based on the ratio adjustment instruction to obtain the target ratio; or
with a photographing apparatus mounted on the movable platform, determining the target ratio based on a composition of the followed target in an image obtained by the photographing apparatus.

In some exemplary embodiments, change trends of the target trajectory and the following trajectory are at least partially inconsistent; and/or
lengths of the target trajectory and the following trajectory are inconsistent.

In some exemplary embodiments, after the processor is configured to control the second motion progress of the movable platform on the following trajectory based on the first motion progress, the processor is further configured to:
obtain a motion progress adjustment instruction from a user, and control, based on the motion progress adjustment instruction, the movable platform to move to adjust the second motion progress.

In some exemplary embodiments, when the processor is configured to control the second motion progress of the movable platform on the following trajectory based on the first motion progress, the processor is specifically configured to:
adjust a position movement speed and/or an attitude change speed of the movable platform based on the first motion progress to adjust the second motion progress of the movable platform on the following trajectory.

In some exemplary embodiments, the position movement speed and/or the attitude change speed are positively correlated with a target difference. The target difference is a difference between a current motion progress and an expected motion progress of the movable platform. The expected motion progress is related to the first motion progress.

In some exemplary embodiments, the target motion trajectory/following trajectory is obtained based on the following manners:
when the followed target/movable platform moves based on a preplanned motion trajectory, sampling position and/or attitude information of the followed target/movable platform at intervals to obtain a plurality of sampling points, and generating the target trajectory/following trajectory based on the plurality of sampling points; or
obtaining an initial pose and a pose change trend of the followed target/movable platform, and generating the target trajectory/following trajectory based on the initial pose and the pose change trend.

In some exemplary embodiments, the target trajectory and/or the following trajectory are generated before the movable platform follows the followed target.

Alternatively, the target trajectory and/or the following trajectory are generated after the movable platform follows the followed target.

In some exemplary embodiments, that the target trajectory and/or the following trajectory are generated before the movable platform follows the followed target includes: The target trajectory and/or the following trajectory are generated before the movable platform takes off, or the target trajectory and/or the following trajectory are generated after the movable platform takes off.

In some exemplary embodiments, a photographing apparatus is mounted on the movable platform. The control apparatus is further configured to:
when the movable platform follows the followed target, control the photographing apparatus to obtain an image of the followed target.

In some exemplary embodiments, the followed target is located at a central position of at least one image obtained by the photographing apparatus.

In some exemplary embodiments, the control apparatus is used in a film and television shooting scenario. The control apparatus is further configured to:
control, based on the first motion progress, a target prop to perform a preset action.

In some exemplary embodiments, the control apparatus is the movable platform, or the control apparatus is a control device communicatively connected to the movable platform.

In some exemplary embodiments, the followed target carries a positioning apparatus. The first motion progress is determined by the positioning apparatus based on real-time position information of the followed target obtained by the positioning apparatus and the target trajectory. The movable platform or the control device obtains the first motion progress from the positioning apparatus.

In some exemplary embodiments, the followed target carries a positioning apparatus. The movable platform or the control device is configured to obtain real-time position information of the followed target obtained by the positioning apparatus, and determine the first motion progress based on the real-time position information and the target trajectory.

In some exemplary embodiments, the target trajectory is obtained from the control device of the movable platform or from a third-party device.

In some exemplary embodiments, the control apparatus is the movable platform. When the control apparatus is configured to obtain the current first motion progress of the followed target on the preset target trajectory, the control apparatus is specifically configured to:
obtain, by the movable platform, the target trajectory of the followed target from a control device, obtain real-time position information of the followed target from a positioning apparatus carried by the followed target, and determine the first motion progress based on the real-time position information and the target trajectory.

When the control apparatus is configured to control the second motion progress of the movable platform on the preset following trajectory based on the first motion progress, the control apparatus is specifically configured to:
adjust, by the movable platform, a motion speed of the movable platform on the preset following trajectory based on the first motion progress such that the second motion progress of the movable platform on the following trajectory is consistent with the first motion progress.

The embodiments of the present disclosure further provide another movable platform control apparatus. As shown in FIG. 9, the control apparatus includes a processor 91, a memory 92, and a computer program stored in the memory 92 and executable by the processor 91. When executing the computer program, the processor 91 may implement the following steps:
obtaining a current first characteristic value of a motion characteristic of a followed target on a preset target trajectory; and
controlling a second characteristic value of the motion characteristic of a movable platform on a preset following trajectory based on the first characteristic value, where the second characteristic value is related to the first characteristic value.

In some exemplary embodiments, the motion characteristic includes one or more of the following:
a motion progress, a motion speed, or a motion step.

In some exemplary embodiments, the first characteristic value is determined based on real-time position information of the followed target.

In some exemplary embodiments, the motion characteristic is a motion progress. The first characteristic value is a proportion of a covered travel of the followed target on the target trajectory in a total travel corresponding to the target trajectory.

Alternatively, the first characteristic value is a proportion of elapsed motion duration of the followed target on the target trajectory in total motion duration corresponding to the target trajectory.

In some exemplary embodiments, the covered travel is determined based on the real-time position information of the followed target and the target trajectory.

In some exemplary embodiments, the followed target carries a positioning apparatus, and the real-time position information is obtained by the positioning apparatus; and/or
a perception sensor is disposed on the movable platform, and the real-time position information is determined based on data obtained by the perception sensor.

In some exemplary embodiments, the perception sensor includes one or more of a vision sensor, a radar, or a UWB positioning system.

In some exemplary embodiments, that the covered travel is determined based on the real-time position information of the followed target and the target trajectory includes:

If it is determined based on the real-time position information of the followed target that a target position point at which the followed target is currently located is not on the target trajectory, a corresponding position point of the target position point is determined on the target trajectory, and the covered travel is determined based on the corresponding position point and the target trajectory.

In some exemplary embodiments, the corresponding position point is a position point closest to the target position point on the target trajectory.

In some exemplary embodiments, that the second characteristic value is related to the first characteristic value includes:
the second characteristic value is consistent with the first characteristic value;
a ratio of the second characteristic value to the first characteristic value is a target ratio; or
a difference between the second characteristic value and the first characteristic value is less than a preset difference threshold.

In some exemplary embodiments, the target ratio is obtained based on any one of the following manners:
obtaining a pre-stored ratio as the target ratio;
receiving a ratio adjustment instruction from a user, and adjusting the pre-stored ratio based on the ratio adjustment instruction to obtain the target ratio; or
with a photographing apparatus mounted on the movable platform, determining the target ratio based on a composition of the followed target in an image obtained by the photographing apparatus.

In some exemplary embodiments, after controlling the second characteristic value of the motion characteristic of the movable platform on the following trajectory based on the first characteristic value, the processor is further configured to:
obtain a motion progress adjustment instruction from a user, and control, based on the motion progress adjustment instruction, the movable platform to move to adjust the second characteristic value.

In some exemplary embodiments, when the processor is configured to control the second characteristic value of the motion characteristic of the movable platform on the following trajectory based on the first characteristic value, the processor is specifically configured to:
adjust a position movement speed and/or an attitude change speed of the movable platform based on the first characteristic value to adjust the second characteristic value of the movable platform on the following trajectory.

In some exemplary embodiments, the position movement speed and/or the attitude change speed are positively correlated with a target difference. The target difference is a difference between a current characteristic value and an expected characteristic value of the motion characteristic of the movable platform. The expected characteristic value is related to the first characteristic value.

In some exemplary embodiments, the control apparatus is used in a film and television shooting scenario. The processor is further configured to:
control, based on the first characteristic value, a target prop to perform a preset action.

In some exemplary embodiments, the control apparatus is the movable platform, or the control apparatus is a control device communicatively connected to the movable platform.

In some exemplary embodiments, the followed target carries a positioning apparatus. The first characteristic value is determined by the positioning apparatus based on real-time position information of the followed target obtained by the positioning apparatus and the target trajectory. The movable platform or the control device obtains the first characteristic value from the positioning apparatus.

In some exemplary embodiments, the followed target carries a positioning apparatus. The movable platform or the control device is configured to obtain real-time position information of the followed target obtained by the positioning apparatus, and determine the first characteristic value based on the real-time position information and the target trajectory.

In some exemplary embodiments, the target trajectory is obtained from the control device of the movable platform or from a third-party device.

In some exemplary embodiments, when the processor is configured to obtain the current first characteristic value of the motion characteristic of the followed target on the preset target trajectory, the processor is specifically configured to:
obtain, by the movable platform, the target trajectory of the followed target from a control device, obtain real-time position information of the followed target from a positioning apparatus carried by the followed target, and determine the first characteristic value based on the real-time position information and the target trajectory.

When the processor is configured to control the second characteristic value of the motion characteristic of the movable platform on the preset following trajectory based on the first characteristic value, the processor is specifically configured to:
adjust, by the movable platform, a motion speed of the movable platform on the preset following trajectory based on the first characteristic value such that the second characteristic value of the motion characteristic of the movable platform on the following trajectory is consistent with the first characteristic value.

The embodiments of the present disclosure further provide a movable platform. A photographing apparatus is mounted on the movable platform. The movable platform further includes a processor, a memory, and a computer instruction stored in the memory. When executing the computer instruction, the processor implements the method in any one of the foregoing embodiments.

Correspondingly, the embodiments of the present disclosure further provide a storage medium of a computer. The storage medium stores a program. When the program is executed by a processor, the method in any one of the foregoing embodiments is implemented.

The embodiments of the present disclosure may use a form of a computer program product implemented on one or more storage media (including but not limited to a disk memory, a compact disc read-only memory (CD-ROM), an optical memory, and the like) that include program code. The computer-usable storage media include persistent, non-persistent, removable, and non-removable media, and storage of information may be implemented through any method or technology. The information may be a computer-readable instruction, a data structure, a module of a program, or other data. Examples of the storage medium of the computer include but are not limited to a phase-change random access memory (PRAM), a static random access memory (SRAM), a dynamic random access memory (DRAM), other types of random access memories (RAMs), a read-only memory (ROM), an electrically erasable programmable ROM (EEPROM), a flash memory or other memory techniques, a CD-ROM, a digital versatile disc (DVD) or other optical storage, a cassette type magnetic tape, disk storage or other magnetic storage devices, or any other non-transmission media, which can be used to store information accessible by a computing device.

For the apparatus embodiments, since it substantially corresponds to the method embodiments, it is sufficient to refer to a part of the description of the method embodiments where relevant. The apparatus embodiments described above are merely schematic. The units described as separate parts may be or may not be physically separate, and parts displayed as units may be or may not be physical units, may be located in one position, or may be distributed on a plurality of network units. Some or all of the modules may be selected based on actual needs to achieve the objectives of the solutions of the embodiments. Those of ordinary skill in the art can understand and implement the embodiments without creative efforts.

It should be noted that relational terms herein such as first and second are merely used to distinguish one entity or operation from another entity or operation without necessarily requiring or implying any actual such relationship or order between such entities or operations. The term “include”, “comprise”, or any other variants thereof is intended to cover a non-exclusive inclusion such that a process, a method, an article, or a device including a series of elements includes not only those elements but also other elements not explicitly listed, or also includes inherent elements of the process, the method, the article, or the device. Without more restrictions, the elements defined by the sentence “including a . . . ” do not exclude the existence of other identical elements in the process, the method, the article, or the device including the elements.

The method and apparatus provided in the embodiments of the present disclosure are described in detail above. The principles and implementations of the present disclosure are described herein by using specific examples. The description of the embodiments is merely provided to help understand the method and core idea of the present disclosure. In addition, a person of ordinary skill in the art can make variations and modifications to the present disclosure in terms of the specific implementations and application scopes according to the idea of the present disclosure. Therefore, content of this disclosure shall not be construed as a limitation on the present disclosure.

What is claimed is:

1. A movable platform control method, comprising:
obtaining a current first motion progress of a followed target on a preset target trajectory; and
controlling a second motion progress of a movable platform on a preset following trajectory based on the first motion progress, wherein the second motion progress is related to the first motion progress.

2. The method according to claim 1, wherein
the target trajectory is at least one of a position change trajectory or an attitude change trajectory of the followed target; or
the following trajectory is at least one of a position change trajectory or an attitude change trajectory of the movable platform; or
a load is disposed on the movable platform, and the following trajectory is at least one of a position change trajectory or an attitude change trajectory of the load.

3. The method according to claim 1, wherein the followed target is a cluster comprising a plurality of target objects, and the target trajectory is at least one of a motion trajectory of a target point determined based on the cluster or a motion trajectory of a performance pattern formed by the plurality of target objects during motion.

4. The method according to claim 3, wherein the followed target is an aerial vehicle cluster performing in the air.

5. The method according to claim 1, wherein the first motion progress is determined based on real-time position information of the followed target; or
the first motion progress is a proportion of a covered travel of the followed target on the target trajectory in a total travel corresponding to the target trajectory; or
the first motion progress is a proportion of elapsed motion duration of the followed target on the target trajectory in a total motion duration corresponding to the target trajectory.

6. The method according to claim 5, wherein the covered travel is determined based on the real-time position information of the followed target and the target trajectory.

7. The method according to claim 5, wherein at least one of a positioning apparatus being carried by the followed target or a perception sensor being disposed on the movable platform;
the real-time position information is obtained by the positioning apparatus or the real-time position information is determined based on data obtained by the perception sensor.

8. The method according to claim 5, wherein that the covered travel is determined based on the real-time position information of the followed target and the target trajectory comprises:
in response to determining the covered travel based on the real-time position information of the followed target that a target position point at which the followed target is currently located is not on the target trajectory, a corresponding position point of the target position point is determined on the target trajectory, and the covered travel is determined based on the corresponding position point and the target trajectory.

9. The method according to claim 5, wherein the target trajectory is at least one of a position change trajectory or an attitude change trajectory of the followed target, the covered travel is at least one of a covered distance or an attitude change of the followed target, and the total travel is at least one of a total distance or a total attitude change corresponding to the target trajectory.

10. The method according to claim 5, wherein the followed target is an aerial vehicle cluster in the air, the elapsed motion duration is an elapsed duration of the followed target, and the total motion duration is a total duration of the followed target.

11. The method according to claim 5, wherein the followed target is an aerial vehicle cluster in the air, the target trajectory is a pattern change trajectory of a plurality of aerial vehicles in the aerial vehicle cluster, the covered travel is a change trajectory of an executed pattern of the plurality of aerial vehicles, and the total travel is a change trajectory of a total pattern of the plurality of aerial vehicles.

12. The method according to claim 1, wherein that the second motion progress is related to the first motion progress comprises:
the second motion progress is consistent with the first motion progress;
a ratio of the second motion progress to the first motion progress is a target ratio; or
a difference between the second motion progress and the first motion progress is less than a preset difference threshold.

13. The method according to claim 1, wherein the target trajectory and the following trajectory are inconsistent in at least one of change trend or length.

14. The method according to claim 1, further comprising:
obtaining, after controlling the second motion progress of the movable platform on the following trajectory based on the first motion progress, a motion progress adjustment instruction from a user; and
controlling, based on the motion progress adjustment instruction, the movable platform to move to adjust the second motion progress.

15. The method according to claim 1, wherein the controlling of the second motion progress of the movable platform on the following trajectory based on the first motion progress comprises:
adjusting at least one of a position movement speed or an attitude change speed of the movable platform based on the first motion progress to adjust the second motion progress of the movable platform on the following trajectory.

16. The method according to claim 15, wherein at least one of the position movement speed or the attitude change speed are positively correlated with a target difference, the target difference is a difference between a current motion progress and an expected motion progress of the movable platform, and the expected motion progress is related to the first motion progress.

17. The method according to claim 1, further comprising:
in response to the movable platform following the followed target, controlling a photographing apparatus mounted on the movable platform to obtain an image of the followed target.

18. The method according to claim 17, wherein the followed target is located at a central position of at least one image obtained by the photographing apparatus.

19. A movable platform control apparatus, comprising:
at least one storage medium storing at least one set of instructions; and
at least one processor in communication with the at least one storage medium, wherein during operation, the at least one processor executes the at least one set of instructions to cause the control apparatus to at least perform:
obtaining a current first motion progress of a followed target on a preset target trajectory, and
controlling a second motion progress of a movable platform on a preset following trajectory based on the first motion progress, wherein the second motion progress is related to the first motion progress.

20. A computer-readable storage medium, wherein the computer-readable storage medium stores a computer program, and the computer program, when executed, implements a method comprising the following steps:
obtaining a current first motion progress of a followed target on a preset target trajectory; and
controlling a second motion progress of a movable platform on a preset following trajectory based on the first motion progress, wherein the second motion progress is related to the first motion progress.
